(19) United States
(12) Patent Application Publication
(10) Pub. No.: US 2016/0198467 A1
(43) Pub. Date: Jul. 7, 2016

(54) MOBILE STATION AND RADIO BASE STATION

(71) Applicant: NTT DOCOMO, INC., Tokyo (JP)

(72) Inventors: Hideaki Takahashi, Tokyo (JP); Wuri Andarmawanti Hapsari, Tokyo (JP); Tooru Uchino, Tokyo (JP); Sadayuki Abeta, Tokyo (JP)

(73) Assignee: NTT DOCOMO, INC., Tokyo (JP)

(21) Appl. No.: 14/910,935

(22) PCT Filed: Aug. 7, 2014
(86) PCT No.: PCT/JP2014/070856

§ 371 Date: Feb. 8, 2016

(30) Foreign Application Priority Data
Aug. 9, 2013 (JP) 2013-166580

(51) Int. Cl. H04W 72/04; H04L 29/12

(52) U.S. Cl. CPC H04W 72/0453; H04L 61/6022

(57) ABSTRACT

Achieved is “Inter-node UP aggregation”. A mobile station UE according to the invention includes a MAC layer function for a radio base station MeNB and a MAC layer function for a radio base station SeNB. Each of the MAC layer function for the radio base station MeNB and the MAC layer function for the radio base station SeNB is configured to determine whether or not MAC-PDU received via a physical layer function is addressed to a logical channel managed by the MAC layer function itself, based on whether or not a MAC-ID is added to a header of the MAC-PDU.

### TECHNICAL FIELD

The present invention relates to a mobile station and a radio base station.

### BACKGROUND ART

As illustrated in FIG. 14(a), in CA (Carrier Aggregation) specified by LTE (Long Term Evolution) Release-10, a high throughput is achievable by performing simultaneous communications using a CC (Component Carrier) #1 and a CC#2 under a same radio base station eNB.

FIG. 15 illustrates a configuration of a layer 2 function in a radio base station eNB to achieve such CA.

As illustrated in FIG. 15, the layer 2 function is configured such that PDCP (Packet Data Convergence Protocol) layer function (PDCP entity) and RLC (Radio Link Control) layer function (RLC entity) are provided dedicatedly to each EPC (Evolved Packet System) bearer in each of an uplink and a downlink for one mobile station UE.

In other words, the layer 2 function is configured to set the PDCP layer function and RLC layer function dedicated to each EPS bearer.

In addition, the layer 2 function is configured to multiplex the multiple bearers in a MAC (Media Access Control Layer function (MAC entity)).

That is, the layer 2 function is configured to set one MAC layer function for each of the uplink and the downlink concerning one mobile station UE.

In addition, the layer 2 function in the mobile station UE for achieving such CA is configured such that one MAC layer function is provided for each of the uplink and the downlink, and PDCP layer function and RLC layer function are provided dedicatedly to each EPS bearer.

On the other hand, in LTE Release-12, there had been discussed “Inter-node UP aggregation” to which CA by LTE Release-10 is extended to perform simultaneous communications using the CC#1/CC#2 under different radio base stations eNB#1/ eNB#2 so as to achieve a high throughput as illustrated in FIG. 14(b) (Non-patent document 1).

For example, when all CCs cannot be accommodated in a single radio base station eNB, the “Inter-node UP aggregation” has to be performed in order to achieve a throughput equivalent to that of LTE Release 10.

### PRIOR ART DOCUMENT

### Non-Patent Document

Non-patent document 1: R2-132250 contribution to 3GPP

### SUMMARY OF THE INVENTION

To achieve “Inter-node UP aggregation”, a mobile station UE has to establish bearers for transmitting and receiving data to/from different radio base stations eNB.

However, there has been a problem that “Inter-node UP aggregation” cannot be achieved because the existing mobile station UE is provided with only one MAC layer function in the layer 2 function, and cannot establish bearers with different radio base stations eNB.

Hence, the invention has been made with a view to the above-described problem, and accordingly has an objective to provide a mobile station and a radio base station which are capable of achieving “Inter-node UP aggregation”.

A first feature of the present invention is summarized as a mobile station configured to be capable of performing carrier aggregation using a component carrier under a first radio base station and a component carrier under a second radio base station, the mobile station comprising: a MAC layer function for the first radio base station; and a MAC layer function for the second radio base station, wherein each of the MAC layer function for the first radio base station and the MAC layer function for the second radio base station is configured to determine whether or not MAC-PDU received via a physical layer function is addressed to a logical channel managed by the MAC layer function itself, based on whether or not predetermined identification information is added to a header of the MAC-PDU.

A second feature of the present invention is summarized as a mobile station configured to be capable of performing carrier aggregation using a component carrier under a first radio base station and a component carrier under a second radio base station, the mobile station comprising: a MAC layer function for the first radio base station; and a MAC layer function for the second radio base station, wherein each of the MAC layer function for the first radio base station and the MAC layer function for the second radio base station is configured to determine whether or not MAC-PDU received via a physical layer function is addressed to a logical channel managed by the MAC layer function itself, based on logical channel identification information included in a header of the MAC-PDU.

A third feature of the present invention is summarized as a mobile station configured to be capable of performing carrier aggregation using a component carrier under a first radio base station and a component carrier under a second radio base station, the mobile station comprising: a MAC layer function for the first radio base station; and a MAC layer function for the second radio base station, wherein each of the MAC layer function for the first radio base station and the MAC layer function for the second radio base station is configured to determine whether or not MAC-SDU received via an RLC layer function is to be processed by the MAC layer function itself, based on whether or not predetermined identification information is added to a header of the MAC-SDU.

A fourth feature of the present invention is summarized as a mobile station configured to be capable of performing carrier aggregation using a component carrier under a first radio base station and a component carrier under a second radio base station, the mobile station comprising: a MAC layer function for the first radio base station; and a MAC layer function for the second radio base station, wherein each of the MAC layer function for the first radio base station and the MAC layer function for the second radio base station is configured to determine whether or not MAC-SDU received via a RLC layer function is to be processed by the MAC layer function itself, based on logical channel identification information included in a header of the MAC-SDU.

A fifth feature of the present invention is summarized as a radio base station functioning as a second radio base station in a mobile communication system in which a mobile station is configured to be capable of performing carrier aggregation using a component carrier under a first radio base station and a component carrier under the second radio base station, the radio base station comprising: a MAC layer function, wherein the MAC layer function is configured to add predetermined identification information to a header of a MAC-SDU to be received via an RLC layer function.

### BRIEF DESCRIPTION OF THE DRAWINGS

FIG. 1 is an overall configuration diagram of a mobile communication system according to a first embodiment of the invention.

FIG. 2 is a diagram illustrating a flow of U-plane data in the mobile communication system according to the first embodiment of the invention.

FIG. 3 is a diagram illustrating protocol stacks of radio base stations eNB#1/eNB#2 according to the first embodiment of the invention.

FIG. 4 is a diagram illustrating functions of a mobile station UE according to the first embodiment of the invention.

FIG. 5 is a sequence diagram illustrating an operation of the mobile communication system according to the first embodiment of the invention.

FIG. 6 is a diagram illustrating protocol stacks of radio base stations eNB#1/eNB#2 according to a modification of the first embodiment of the invention.

FIG. 7 is a diagram illustrating protocol stacks of the radio base stations eNB#1/eNB#2 according to the modification of the first embodiment of the invention.

FIG. 8 is a diagram illustrating protocol stacks of the radio base stations eNB#1/eNB#2 according to the modification of the first embodiment of the invention.

FIG. 9 is a diagram illustrating a flow of U-plane data in a mobile communication system according to a second embodiment of the invention.

FIG. 10 is a diagram illustrating protocol stacks of radio base stations eNB#1/eNB#2 according to the second embodiment of the invention.

FIG. 11 is a diagram illustrating functions of a mobile station UE according to the second embodiment of the invention.

FIG. 12 is a diagram illustrating protocol stacks of radio base stations eNB#1/eNB#2 according to a modification of the second embodiment of the invention.

FIG. 13 is a diagram illustrating protocol stacks of the radio base stations eNB#1/eNB#2 according to the modification of the second embodiment of the invention.

FIG. 14 illustrates a configuration example of conventional component carriers.

FIG. 15 is a configuration diagram of a conventional layer 2 function in a radio base station for achieving CA.

### MODES FOR CARRYING OUT THE INVENTION

### Mobile Communication System according to First Embodiment of the Invention

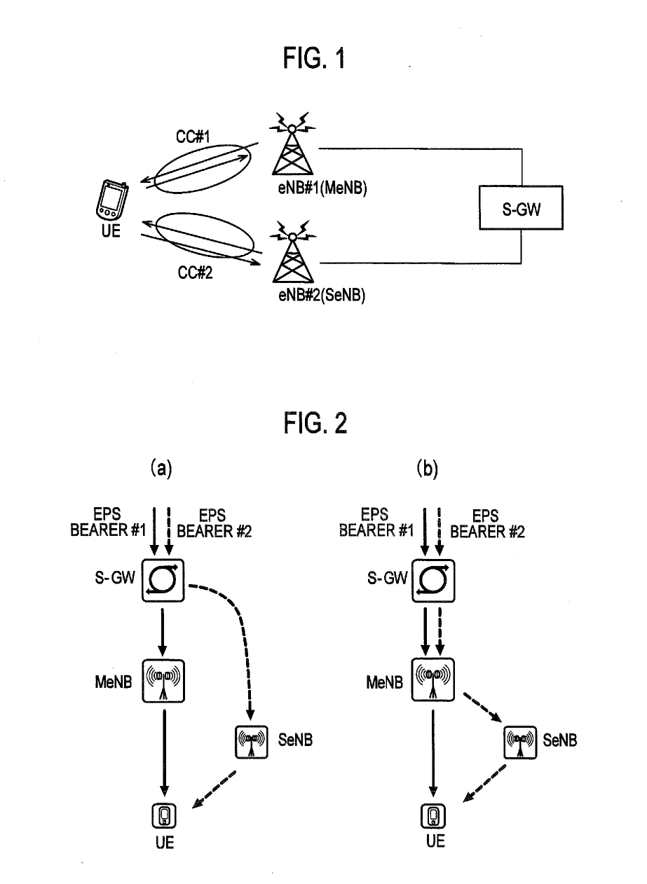

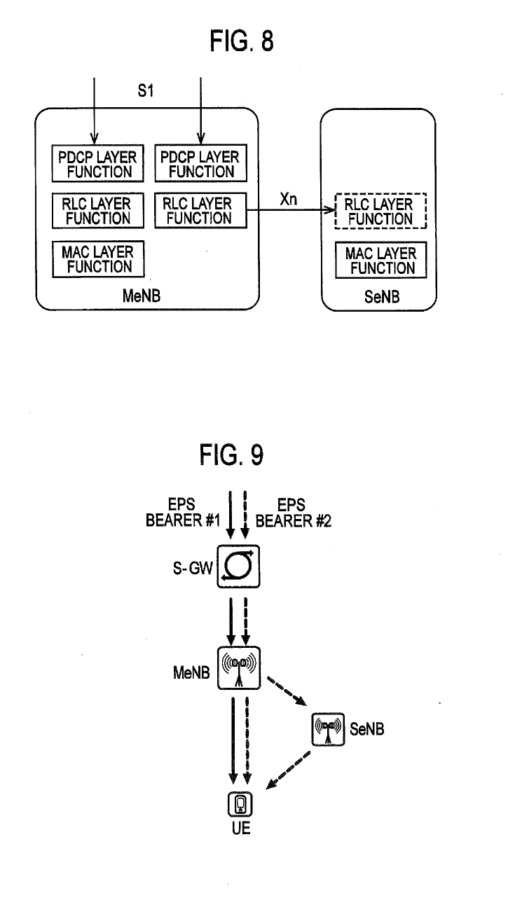

Referring to FIG. 1 to FIG. 8, a mobile communication system according to a first embodiment of the invention is described.

As illustrated in FIG. 1, the mobile communication system according to the embodiment is an LTE mobile communication system which includes a gateway device S-GW, a radio base station eNB#1, a radio base station eNB#2, and a mobile station UE.

In the mobile communication system according to the embodiment, the mobile station UE is configured to be capable of performing CA using a CC#1 under the radio base station eNB#1 and a CC#2 under the radio base station eNB#2.

In other words, the mobile communication system according to the embodiment is configured to be capable of performing “Inter-node UP aggregation”.

Note that, the mobile station UE is configured to perform communications using one or multiple EPS bearers when the “Inter-node UP aggregation” is performed.

It is assumed in the mobile communication system according to the embodiment that the radio base station eNB#1 is a radio base station MeNB (Master eNB) such as a radio base station eNB which manages a macro cell and the radio base station eNB#2 is a radio base station SeNB (Secondary eNB) such as a radio base station eNB which manages a small cell.

In addition, as illustrated in FIG. 2(a) and FIG. 2(b), the mobile communication system according to the embodiment is configured such that when the “Inter-node UP aggregation” is performed, U-plane data on a same EPS bearer flows to only either one of the radio base station MeNB and the radio base station SeNB.

Here, the U-plane data may be configured to flow from the gateway device S-GW to the radio base station SeNB as illustrated in FIG. 2(a) or may be configured to flow from the radio base station MeNB to the radio base station SeNB as illustrated in FIG. 2(b).

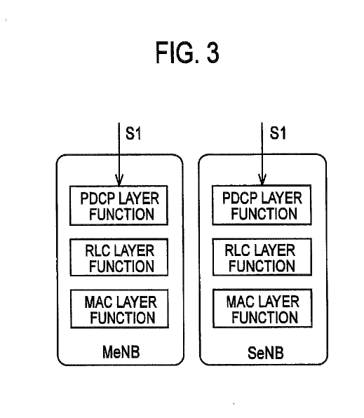

Moreover, as illustrated in FIG. 3, in the mobile communication system according to the embodiment, each of the radio base station MeNB and the radio base station SeNB includes a MAC layer function, an RLC layer function, and a PDCP layer function.

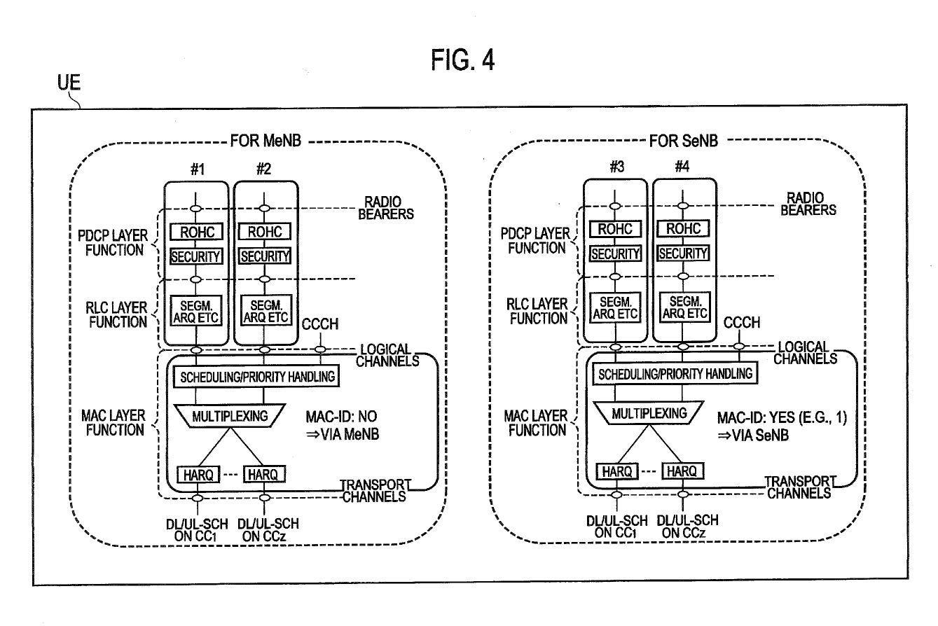

As illustrated in FIG. 4, the mobile station UE includes a MAC layer function for the radio base station MeNB and a MAC layer function for the radio base station SeNB as the layer 2 function.

In addition, the mobile station UE includes PDCP layer function and RLC layer function dedicated to each EPS bearer as the layer 2 function.

Here, in the downlink, each of the MAC layer function for the radio base station MeNB and the MAC layer function for the radio base station SeNB maybe configured to determine whether or not MAC-PDU received via the physical layer function is addressed to a logical channel (EPS bearer) managed by the MAC layer function itself, based on whether or not a MAC-ID is added to a header of the MAC-PDU.

For example, the MAC layer function for the radio base station MeNB may be configured to determine that the MAC-PDU received via the physical layer function is addressed to the logical channel managed by the MAC layer function itself when the MAC-ID is not added to the header of the MAC-PDU.

According to the above feature, “backward compatibility” with the existing LTE is achievable. In other words, the MAC layer function for the radio base station MeNB may be a MAC layer function in the existing LTE.

On the other hand, the MAC layer function for the radio base station SeNB may be configured to determine that the MAC-PDU received via the physical layer function is addressed to the logical channel managed by the MAC layer function itself when the MAC-ID is added to the header of the MAC-PDU.

In such a case, the MAC layer function in the radio base station SeNB is configured to add a MAC-ID to a header of MAC-SDU to be received via an RLC layer function.

On the other hand, the MAC layer function in the radio base station MeNB is configured not to add a MAC-ID to the header of the MAC-SDU to be received via the RLC layer function.

Alternatively, each of the MAC layer function for the radio base station MeNB and the MAC layer function for the radio base station SeNB is configured to determine whether or not the MAC-PDU received via the physical layer function is addressed to the logical channel managed by the MAC layer function itself based on a value of the MAC-ID added to the header of the MAC-PDU.

Note that, the MAC-ID is configured to be notified by using an RRC layer signal such as “RRCConnectionReconfiguration” by the radio base station MeNB or the radio base station SeNB.

In addition, in the downlink, the MAC layer function for the radio base station MeNB and the MAC layer function for the radio base station SeNB maybe configured to determine whether or not the MAC-PDU received via the physical layer function is addressed to the logical channel managed by the MAC layer function itself based on an LCN-ID (Logical Channel ID) which is included in the header of the MAC-PDU.

In such a case, each of the MAC layer function for the radio base station MeNB and the MAC layer function for the radio base station SeNB is configured to store the LCN-ID of the logical channel managed by the MAC layer function itself.

Here, the LCN-ID may be an LCN-ID which is used in the existing LTE.

On the other hand, in the uplink, each of the MAC layer function for the radio base station MeNB and the MAC layer function for the radio base station SeNB may be configured to determine whether or not MAC-SDU received via the RLC layer function is to be processed by the MAC layer function itself, based on whether or not the MAC-ID is added to the header of the MAC-SDU.

For example, the MAC layer function for the radio base station MeNB may be configured to determine the MAC-SDU received via the RLC layer function is to be processed by the MAC layer function itself when the MAC-ID is not added to the header of the MAC-SDU.

According to the above feature, “backward compatibility” with the existing LTE is achievable. In other words, the MAC layer function for the radio base station MeNB may be a MAC layer function in the existing LTE.

On the other hand, the MAC layer function for the radio base station SeNB may be configured to determine that the MAC-SDU received via the RLC layer function is to be processed by the MAC layer function itself when the MAC-ID is added to the header of the MAC-SDU.

Alternatively, each of the MAC layer function for the radio base station MeNB and the MAC layer function for the radio base station SeNB is configured to determine whether or not the MAC-SDU received via the physical layer function is to be processed by the MAC layer function itself based on a value of the MAC-ID added to the header of the MAC-SDU.

Moreover, in the uplink, the MAC layer function for the radio base station MeNB and the MAC layer function for the radio base station SeNB may be configured to determine whether or not the MAC-SDU received via the RLC layer function is to be processed by the MAC layer function itself based on the LCN-ID included in the header of the MAC-SDU.

In such a case, each of the MAC layer function for the radio base station MeNB and the MAC layer function for the radio base station SeNB is configured to store the LCN-ID of the logical channel managed by the MAC layer function itself.

Here, the LCN-ID may be the LCN-ID which is used in the existing LTE.

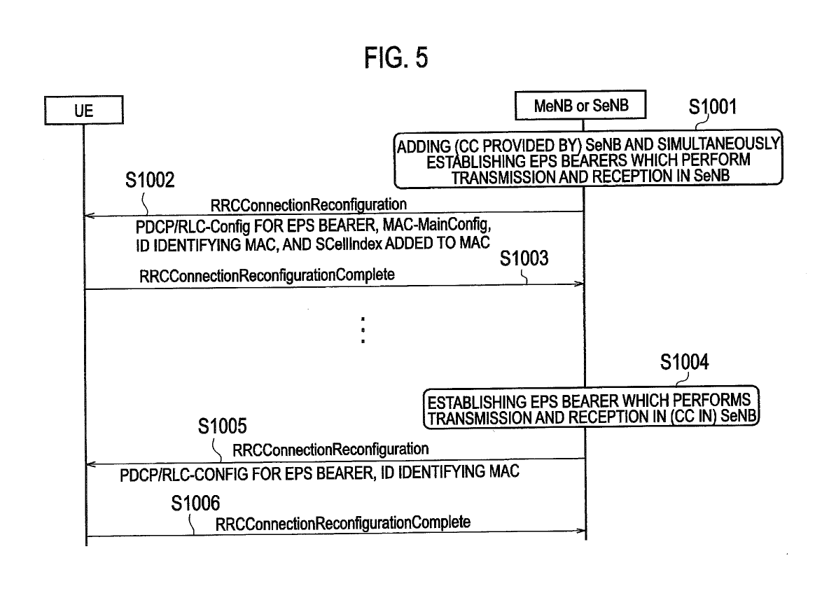

Hereinafter, an operation of the mobile communication system according to the embodiment is described by referring to FIG. 5.

As illustrated in FIG. 5, at step S1001, when the mobile station UE is in connection with the radio base station MeNB, the radio base station MeNB (or the radio base station SeNB) sets the radio base station SeNB (or the CC which is provided by the radio base station SeNB) and establishes an EPS bearer which performs transmission and reception in the radio base station SeNB.

At step S1002, the radio base station MeNB (or the radio base station SeNB) transmits “RRCConnectionReconfiguration” to the mobile station UE.

The “RRCConnectionReconfiguration” is configured to notify “PDCP/RLC Config” for the established EPS bearer, “MAC-MainConfig”, “MAC-ID”, “ScellIndex” addedto the MAC layer function, and the like.

At step S1003, the mobile station UE transmits “RRCConnectionReconfigurationComplete” in response to the “RRCConnectionReconguration” to the radio base station MeNB (or the radio base station SeNB).

At step S1004, the radio base station MeNB (or the radio base station SeNB) establishes an EPS bearer which performs transmission and reception in the radio base station SeNB (the CC in the radio base station SeNB).

At step S1005, the radio base station MeNB (or the radio base station SeNB) transmits the “RRCConnectionReconfiguration” to the mobile station UE.

The “RRCConnectionReconfiguration” is configured to notify “PDCP/RLC Config” for the established EPS bearer, “MAC-ID”, and the like.

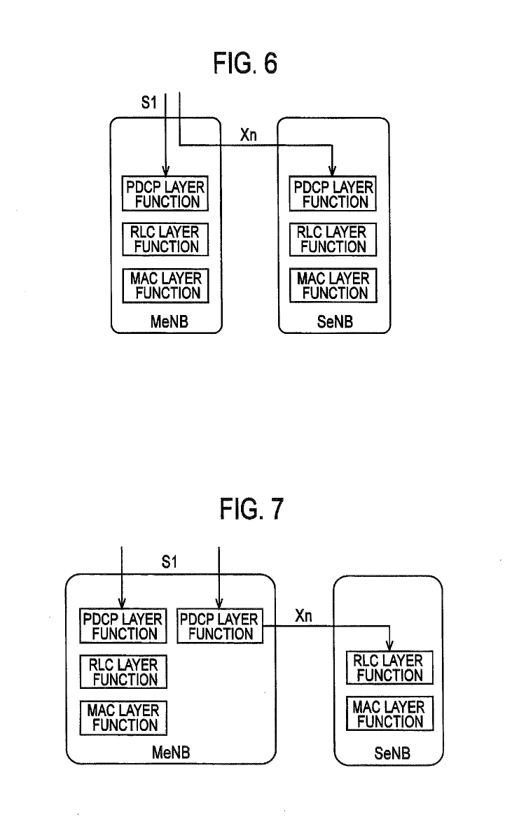

Note that, in the mobile communication system according to the embodiment, protocol stacks of the radio base station MeNB and the radio base station SeNB may be configured as illustrated in FIG. 6 to FIG. 8.

In the mobile communication system according to the embodiment, when “Inter-node UP aggregation” is started, the mobile station UE sets MAC layer functions respectively dedicated to the radio base station MeNB and the radio base station SeNB, and establishes EPS bearers to be processed by each of the MAC layer functions. Thereby, even when the “Inter-node UP aggregation” is performed, the mobile station UE is capable of properly performing an operation such as determining which EPS bearers are to be multiplexed in which MAC layer function for each radio base station eNB.

### Mobile Communication System according to Second Embodiment of the Invention

Hereinafter, by referring to FIG. 9 to FIG. 11, a mobile communication system according to a second embodiment of the invention is described by paying attention to differences from the mobile communication system according to the above-described first embodiment.

In the mobile communication system according to the embodiment, as illustrated in FIG. 9, U-plane data on a same EPS bearer (for example, U-plane data on an EPS bearer#2) is configured to flow to both of a radio base station MeNB and a radio base station SeNB when “Inter-node UP aggregation” is performed.

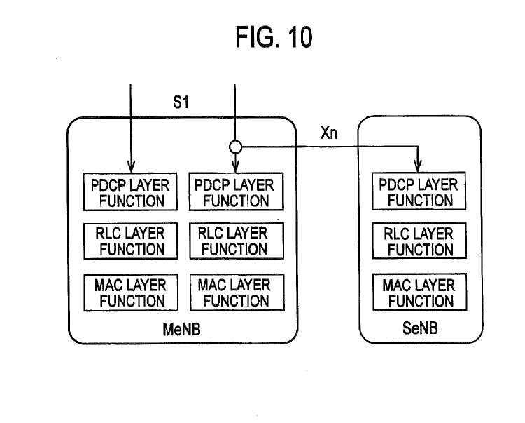

In addition, as illustrated in FIG. 10, in the mobile communication system according to the embodiment, the radio base station MeNB is configured to include a layer 2 function for an EPS bearer #1 as well as a layer 2 function for an EPS bearer #2.

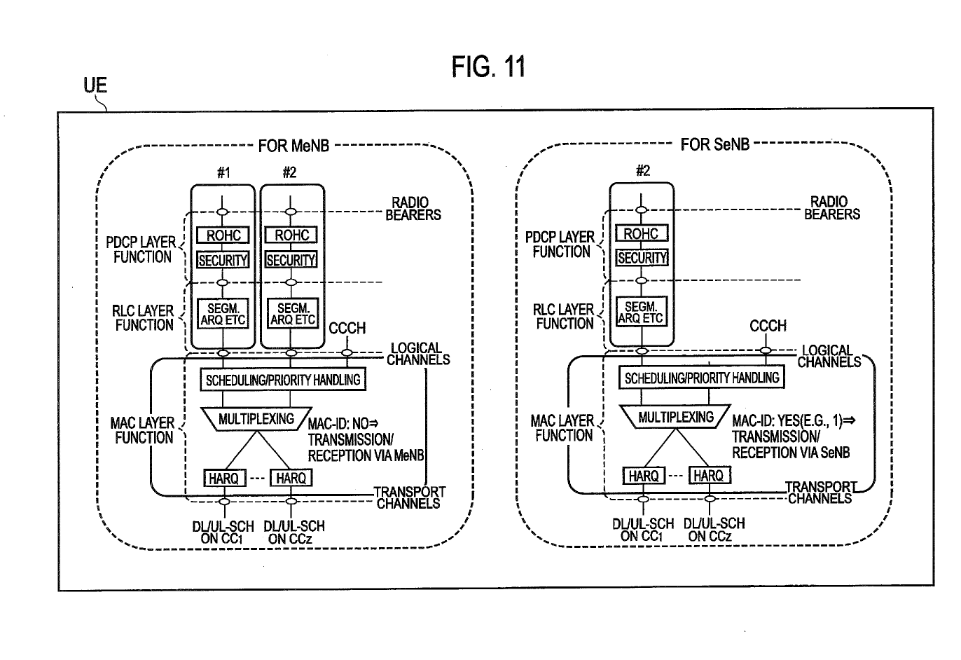

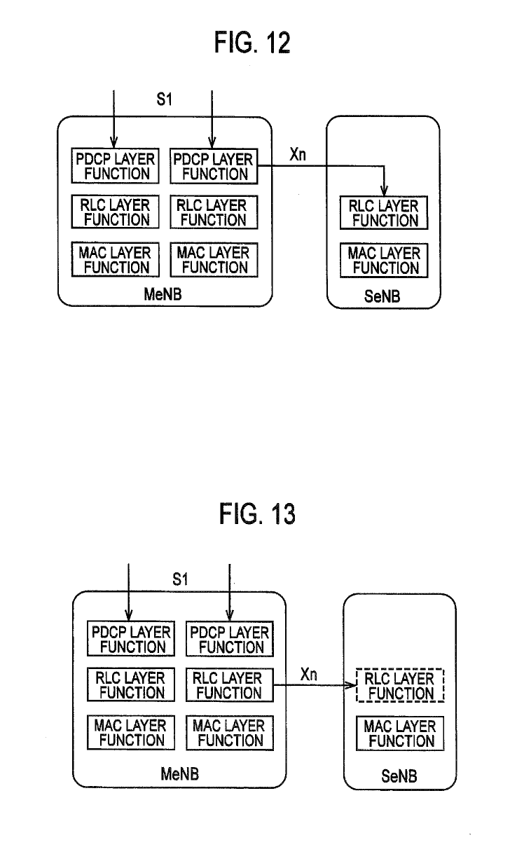

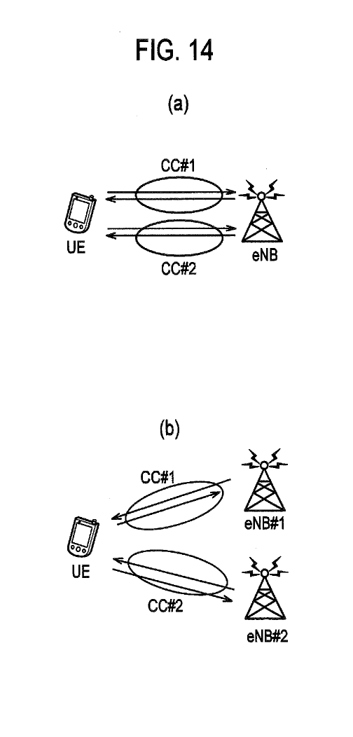

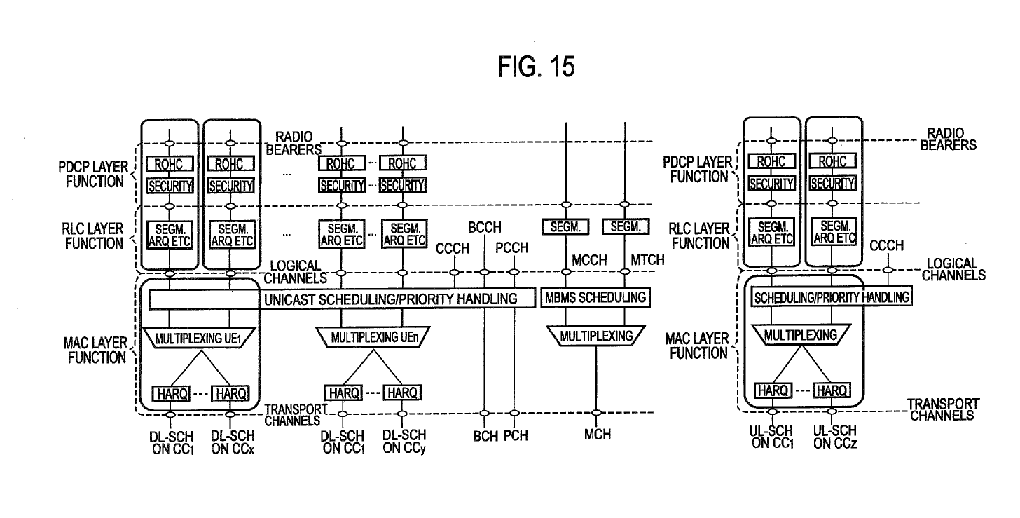

As illustrated in FIG. 11, in the mobile communication system according to the embodiment, the mobile station UE is configured to set a PDCP layer function and an RLC layer function for a same EPS bearer (in the example of FIG. 11, the EPS bearer #2) in both the layer 2 function for the radio base station MeNB and the layer 2 function for the radio base station SeNB.

In other words, both the MAC layer function for the radio base station MeNB and the MAC layer function for the radio base station SeNB are configured to use the EPS bearer #2 as a logical channel (EPS bearer) managed by the MAC layer function itself.

The foregoing features of the present embodiments may be expressed as follows.

In summary, a first feature of the present embodiments is a mobile station UE configured to be capable of performing CA (carrier aggregation) using a CC (component carrier) under a radio base station MeNB (a first radio base station) and a CC under a radio base station SeNB (a second radio base station), the mobile station UE comprising: a MAC layer function for the radio base station MeNB; and a MAC layer function for the radio base station SeNB, wherein each of the MAC layer function for the radio base station MeNB and the MAC layer function for the radio base station SeNB is configured to determine whether or not MAC-PDU received via a physical layer function is addressed to a logical channel managed by the MAC layer function itself, based on whether or not a MAC-ID (predetermined identification information) is added to a header of the MAC-PDU.

In summary, a second feature of the present embodiments is a mobile station UE configured to be capable of performing CA using a CC under a radio base station MeNB and a CC under a radio base station SeNB, the mobile station UE comprising: a MAC layer function for the radio base station MeNB; and a MAC layer function for the radio base station SeNB, wherein each of the MAC layer function for the radio base station MeNB and the MAC layer function for the radio base station SeNB is configured to determine whether or not MAC-PDU received via a physical layer function is addressed to a logical channel managed by the MAC layer function itself, based on an LCN-ID (logical channel identification information) included in a header of the MAC-PDU.

In summary, a third feature of the present embodiments is a mobile station UE configured to be capable of performing CA using a CC under a radio base station MeNB and a CC under a radio base station SeNB, the mobile station UE comprising: a MAC layer function for the radio base station MeNB; and a MAC layer function for the radio base station SeNB, wherein each of the MAC layer function for the radio base station MeNB and the MAC layer function for the radio base station SeNB is configured to determine whether or not MAC-SDU received via an RLC layer function is to be processed by the MAC layer function itself, based on whether or not a MAC-ID is added to a header of the MAC-SDU.

In summary, a fourth feature of the present embodiment is a mobile station UE configured to be capable of performing CA using a CC under a radio base station MeNB and a CC under a radio base station SeNB, the mobile station UE comprising: a MAC layer function for the radio base station MeNB; and a MAC layer function for the radio base station SeNB, wherein each the MAC layer function for the radio base station MeNB and the MAC layer function for the radio base station SeNB is configured to determine whether or not MAC-SDU received via a RLC layer function is to be processed by the MAC layer function itself, based on an LCN-ID included in a header of the MAC-SDU.

In summary, a fifth feature of the present embodiment is a radio base station eNB functioning as a radio base station SeNB in a mobile communication system in which a mobile station UE is configured to be capable of performing CA using a CC under a radio base station MeNB and a CC under the radio base station SeNB, the radio base station eNB comprising: a MAC layer function, wherein the MAC layer function is configured to add a MAC-ID to a header of a MAC-SDU to be received via an RLC layer function.

It should be noted that the foregoing operations of the mobile station UE and the radio base stations eNB#1/eNB#2 may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile station UE or the radio base station eNB#1/eNB#2. Otherwise, the storage medium and the processor may be provided as discrete components inside the mobile station UE or the radio base station eNB#1/eNB#2.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2013-166580 (filed on Aug. 9, 2013) is incorporated by reference in the present specification.

### INDUSTRIAL APPLICABILITY

As described above, the invention may provide a mobile station and radio base station which are capable of achieving “Inter-node UP aggregation”.

### EXPLANATION OF REFERENCE NUMERALS

S-GW Gateway device

eNB#1(MeNB), eNB#2(SeNB) Radio base station

UE Mobile station

1. A mobile station performing carrier aggregation using a component carrier under a first radio base station and a component carrier under a second radio base station, the mobile station comprising:
a MAC layer function for the first radio base station; and
a MAC layer function for the second radio base station, wherein
each of the MAC layer function for the first radio base station and the MAC layer function for the second radio base station is configured to determine whether or not MAC-PDU received via a physical layer function is addressed to a logical channel managed by the MAC layer function itself, based on whether or not predetermined identification information is added to a header of the MAC-PDU.

2. A mobile station performing carrier aggregation using a component carrier under a first radio base station and a component carrier under a second radio base station, the mobile station comprising:
a MAC layer function for the first radio base station; and
a MAC layer function for the second radio base station, wherein
each of the MAC layer function for the first radio base station and the MAC layer function for the second radio base station is configured to determine whether or not MAC-PDU received via a physical layer function is addressed to a logical channel managed by the MAC layer function itself, based on logical channel identification information included in a header of the MAC-PDU.

3. A mobile station performing carrier aggregation using a component carrier under a first radio base station and a component carrier under a second radio base station, the mobile station comprising:
a MAC layer function for the first radio base station; and
a MAC layer function for the second radio base station, wherein
each of the MAC layer function for the first radio base station and the MAC layer function for the second radio base station is configured to determine whether or not MAC-SDU received via an RLC layer function is to be processed by the MAC layer function itself, based on whether or not predetermined identification information identifying the MAC layer function is added to a header of the MAC-SDU.

4. A mobile station performing carrier aggregation using a component carrier under a first radio base station and a component carrier under a second radio base station, the mobile station comprising:
a MAC layer function for the first radio base station; and
a MAC layer function for the second radio base station, wherein
each of the MAC layer function for the first radio base station and the MAC layer function for the second radio base station is configured to determine whether or not MAC-SDU received via a RLC layer function is to be processed by the MAC layer function itself, based on logical channel identification information included in a header of the MAC-SDU.

5. A radio base station functioning as a second radio base station in a mobile communication system in which a mobile station is configured to be capable of performing carrier aggregation using a component carrier under a first radio base station and a component carrier under the second radio base station,
the radio base station comprising a MAC layer function, wherein
the MAC layer function is configured to add predetermined identification information identifying the MAC layer function to a header of a MAC-SDU to be received via an RLC layer function.
